(19) United States
(12) Patent Application Publication
(10) Pub. No.: US 2011/0049740 A1
(43) Pub. Date: Mar. 3, 2011

(54) PROCESS FOR PRODUCTION OF COLOURED POWDER COSMETIC PRODUCTS BY MEANS OF FREEZING

(75) Inventor: Marco LAZZARINI, Milano (IT)

(73) Assignee: INTERCOS S.p.A., Milano (IT)

(21) Appl. No.: 12/861,577

(22) Filed: Aug. 23, 2010

(30) Foreign Application Priority Data
Aug. 26, 2009 (IT) MI2009A001506

(51) Int. Cl. B29C 39/38; B29C 35/16; B29C 35/02; B29C 71/02

(52) U.S. Cl. 264/28

(57) ABSTRACT

An innovative process is described for production of coloured powder cosmetic products. The process comprises forming a “slurry” (1) consisting of a powder cosmetic product and of water and/or solvent, pouring the slurry in a container (2) of anti-adhering material with shaped internal bottom (3) and smooth internal sidewalk (4). The slurry (1) poured into the container (2) is subjected to slight pressing by means of a plate (5) superimposed thereon. The process then provides freezing the slurry (1) inside the container (2) with the plate (5) arranged to close the top of the container (2), extracting and overturning the assembly consisting of the slurry (1) and of the plate (5) and putting such assembly (1, 5) into a cooking room.

The present invention relates to a process for production of coloured powder cosmetic products.

Production processes are known of coloured cosmetic products by means of pressing powders or by means of drying a powdery step dispersed in solvents, e.g. water or organic solvents.

With the traditional pressing process the cosmetic powders are pressed into a metallic container, commonly called “godet”, under strong pressure, until a compact and homogeneous bar of product is obtained.

This is the most known and widespread process and has many positive aspects, such as the elevated productivity of the system, the flexibility of the process and contained costs of the finished product, but it also has some negative aspects, such as the impossibility to create particularly high and angular reliefs, and not a very bright or smooth product surface.

With regards to the height of the reliefs, it is not possible to exceed certain levels because when the relief starts exceeding 2 mm, the difference in consistency between the various levels of compactness becomes increasingly relevant, thus creating different consistencies within the powder itself and non-homogeneous spreading between the various points of the product.

With regards to the surface of the compacted product, the compressed powder forms a slightly “rough” superficial layer so that the light which strikes the surface is reflected in non-uniform manner and causes the superficial opacity of the product.

Additionally, having to use detaching materials placed as gaps between the cover of the compacting mould and the product itself, e.g., cloths in polyester or the likes, the employment of such cloths creates a “textured” surface like the weave of the cloths themselves, and this increases the opacity of the surface of the compacted piece even more.

The other technique used to make powder cosmetic products is the so-called “cooked” one wherein the coloured powder, transformed into a muddy “slurry” by means of the employment of water, organic solvent or a water+organic solvent mixture, is deposited on a plate, generally made with terracotta, and then pressed to give the final form.

The product thus obtained is then cooked in a kiln, usually at temperatures comprised between 40° C. and 60° C.

A variant of the latter process provides the extrusion of the slurry in form of thin strip, the incision of the strip with suitably shaped punches, the union of the various incised shapes in the same godet, the slight pressing of the various shaped tesserae, also with moulds which comprise reliefs, and the cooking of the pieces in an oven.

After cooking the pieces, the products could be scratched on the surface to remove that very small waxy layer which is formed during cooking and which could penalize the removal of the product itself.

In this case, the possible relief is formed in a successive compacting step, which, however, is always done, whether or not the surface is scratched.

However, in both cases there are considerable limitations in the definition of the forms, which, due to the fact that an already compact product should be shaped, are always rounded and never angular, the height of the reliefs is never particularly elevated, max. 2 mm in height, and here too, as in the case of the pressed powders, the surface is opaque, never shiny and bright, also due to the fact that a detaching film, generally a very thin cloth of synthetic material, such as polyester, etc., should be interposed between the compacting head and the product to be pressed, which prevents the product from adhering to the compacting mould.

The object of the present invention is to overcome these drawbacks by creating a production process capable of giving rise to a cosmetic product to which high and angular reliefs can be given, and which may have a bright and smooth surface.

To achieve such object a production process was fine-tuned according to the present invention, which provides forming a “slurry” consisting of a powder cosmetic product and of water and/or solvent, pouring the slurry into a container of an anti-adhering material with shaped internal bottom and smooth internal sidewalls, superimposing a plate onto said slurry, slightly pressing the slurry by means of said plate, freezing the slurry thus pressed inside the container with said plate being arranged to close the top of the container, extracting and overturning the assembly consisting of the slurry and of the plate and putting said assembly into a cooking room.

The advantages deriving from the employment of this new process are multiple:

1) the product is dosed directly in the container having shaped bottom and pressed upside down with respect to traditional systems, therefore it adapts perfectly to the walls without the need for shaped compacting moulds;

2) the product dosed in the container having shaped bottom is pressed without the need for anti-adhering cloths, because the container is already anti-adherent;

3) detachment occurs easily due to the self-detaching nature of the material of the container, therefore possible problems are avoided of adhesion of the product to the cloth;

4) by coming in contact with the smooth sidewalls, the product has the same smooth surface as the walls of the container, also after cooking;

5) as anti-adhering cloths are no longer required, the product adapts to the form of the container having shaped bottom, thus also creating very acute angles and forming reliefs and heights decidedly greater than those which may be made with the traditional techniques.

It is essential that the container used for forming and freezing the cosmetic product consists of an anti-adhering material which facilitates “turning out” the product once consolidated at low temperatures. The container should also be capable of being formed with very different, high and angular shapes, with extremely smooth walls.

Silicone or silicone compounds may be used for the purpose, but metallic moulds coated with silicone or any other material with similar characteristics could also be employed.

With regards to the product, the solidification thereof occurs at low temperatures, generally in a freezer having variable temperatures from −10° C. to −25° C., for just as variable times from 10 minutes to 60 minutes.

These data are influenced by the formulation of the product, which could contain more or less solvent, by the type of solvent, which may consist of 100% water or mixtures of water and organic solvents, and by the quantity of product arranged to freeze.

An example of the innovative production process of the coloured cosmetic product and shaped according to the present invention is illustrated in the accompanying drawings, in which:

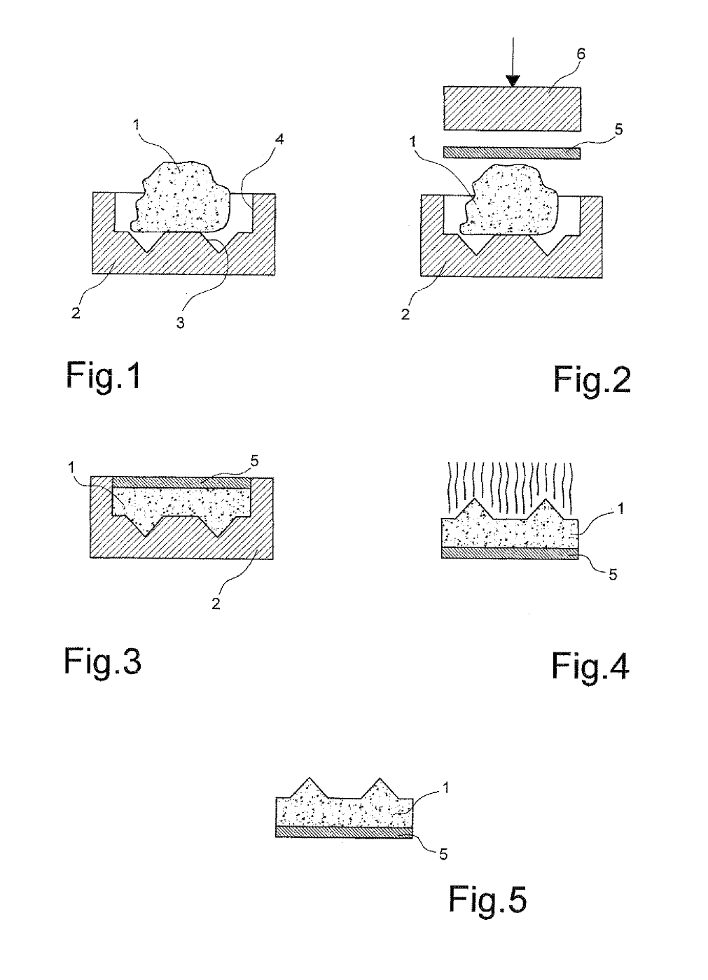

FIGS. 1-4 show respective successive steps of the production process;

FIG. 5 shows the finished product at the end of the aforementioned process.

Starting from FIG. 1, a “slurry” cosmetic product 1 previously formed is dosed inside a container 2 in anti-adhering material, in particular of siliconic type, which has pre-shaped internal bottom 3 and smooth internal sidewalls 4.

FIG. 2 shows that a plate 5 is positioned on top of the cosmetic product 1 arranged in the container 2, usually made with terracotta or similar material, which at the end of the process performs the function of base for the insertion and the pouring in the sales container and should be in porous material to permit the partial absorption of the water or of the solvent used for the dispersion of the loose cosmetic material in the slurry formation step.

The plate 5 is compressed onto the product 1 by means of the employment of a press 6, also shown in FIG. 2.

FIG. 3 shows that, after pressing, the cosmetic product 1 arranged in the container 2 has been shaped perfectly inside the container itself and “plugged” with the plate 5.

The container 2 with the cosmetic product 2 and the closure plate 5 is successively arranged in a freezer at a variable temperature from −10° C. to −25° C. for variable times from 10 to 60 minutes, or however until obtaining a product sufficiently solid to be capable of being extracted already formed, from the container 2 and successively manipulable without problem.

At this point (FIG. 4), the product 1, frozen, solidified and shaped, arranged on the plate 5, is put into an oven or other cooking room at temperatures oscillating from 40° C. to 60° C., until the complete drying of the product itself.

FIG. 5 shows the finished dried cosmetic product, ready for insertion into a sales container.

1. Process for production of coloured powder cosmetic products, comprising:
forming of a “slurry” (1) comprising a powder cosmetic product and water and/or solvent,
pouring of the slurry into a container (2) of an anti-adhering material with a shaped internal bottom (3) and smooth internal sidewalls (4),
superimposing of a plate (5) on said slurry (1),
slight pressing of the slurry (1) through said plate (5),
freezing of the pressed slurry (1) inside the container (2) with said plate (5) being arranged to close the top of the container (2),
extracting and overturning of the assembly formed by the slurry (1) and by the plate (5) and
putting of said assembly (1, 5) into a cooking room.

2. Process according to claim 1, wherein said anti-adhering material of the container (2) consists of silicone or its compound.

3. Process according to claim 1, wherein said anti-adhering material of the container (2) is formed by an internal coating of silicone or its compound.

4. Process according to claim 1, wherein said plate (5) is made of porous material, such as terracotta or the like.

5. Process according to claim 1, wherein said freezing of the slurry (1) is carried out at a temperature between −10° C. and −25° C. for a variable time between 10 and 60 minutes.

6. Process according to claim 1, wherein said cooking room is at a temperature comprised between 40° C. and 60° C.
